(19) United States
(12) Patent Application Publication
(10) Pub. No.: US 2016/0219917 A1
(43) Pub. Date: Aug. 4, 2016

(54) PROCESS FOR TEXTURING A MICROALGAL BIOMASS

(71) Applicant: ROQUETTE FRERES, Lestrem (FR)

(72) Inventor: Damien PASSE, Douai (FR)

(21) Appl. No.: 15/025,557

(22) PCT Filed: Oct. 17, 2014
(86) PCT No.: PCT/FR2014/052648

§ 371 Date: Mar. 29, 2016

(30) Foreign Application Priority Data
Oct. 18, 2013 (FR) 13 60202

(51) Int. Cl. A23L 1/337

(52) U.S. Cl. CPC A23L 1/337; A23L 1/3055; A23V 2002/00

(57) ABSTRACT

A process for texturing microalgal biomass flour includes the following steps: (a) introducing water, microalgal flour and, optionally, a vegetable protein source into a solid-liquid mixer, (b) emulsifying and homogenizing the content of the solid-liquid mixer, (c) optionally, placing the internal space of the mixer at low pressure or under vacuum.

The present invention relates to a process for texturing a microalgal biomass, preferably of the Chlorella genus, more particularly Chlorella protothecoides or Chlorella sorokiniana.

It is well known to those skilled in the art that microalgae of the Chlorella genus are a potential source of food, since they are rich in proteins and other essential nutrients.

On average, they contain 45% of proteins, 20% of fats, 20% of carbohydrates, 5% of fibers and 10% of minerals and vitamins.

The oil fraction of the Chlorella biomass, which is composed essentially of monounsaturated oils, thus provides nutritional and health advantages compared with the saturated, hydrogenated and polyunsaturated oils often found in conventional food products.

Chlorella are thus utilized in food for human or animal consumption, either in the form of whole biomass or in the form of flour, obtained by drying biomass of chlorella, the cell wall of which has been broken by in particular mechanical means.

The microalgal flour also provides other benefits, such as micronutrients, dietary fibers (soluble and insoluble carbohydrates), phospholipids, glycoproteins, phytosterols, tocopherols, tocotrienols and selenium.

In order to prepare the biomass which will be incorporated into the food composition, the biomass is concentrated, or harvested, from the culture medium (culturing by photoautotrophy in photobioreactors, or heterotrophically in darkness and in the presence of a source of carbon which can be assimilated by the chlorella).

In the technical field to which the invention relates, the heterotrophic growth of chlorella is preferred (what is known as the fermenting route).

At the time of the harvesting of the microalgal biomass from the fermentation medium, the biomass comprises intact cells which are mostly in suspension in an aqueous culture medium.

In order to concentrate the biomass, a solid-liquid separation step is then carried out by frontal or tangential filtration, by centrifugation or by any means known, moreover, to those skilled in the art.

After concentration, the microalgal biomass can be treated directly in order to produce vacuum-packed cakes, algal flakes, algal homogenates, intact algal flour, milled algal flour or algal oil.

The microalgal biomass is also dried in order to facilitate the subsequent treatment or for use of the biomass in its various applications, in particular food applications.

In order to confer texture and/or flavor on this (milled or unmilled) microalgal flour incorporated into foods, it is conventionally chosen by those skilled in the art to dry the biomass using various drying methods.

For example, U.S. Pat. No. 6,607,900 describes drying the microalgal biomass using a drum dryer without any prior centrifugation, in order to prepare microalgal flakes.

Microalgal powder may be prepared from microalgal biomass concentrated using a pneumatic dryer or by spray-drying, as described in U.S. Pat. No. 6,372,460.

In a spray-dryer, a liquid suspension is then sprayed in the form of a dispersion of fine droplets in a stream of heated air. The entrained material is rapidly dried and forms a dry powder.

In other instances, a combination of spray-drying followed by the use of a fluidized bed dryer is used to achieve improved conditions for obtaining a dried microalgal biomass (see, for example, U.S. Pat. No. 6,255,505).

In the technical field addressed by the invention, it is sought more particularly to prepare a flour of fermentatively produced algae having a particular texture, characterized by its gelling or coating power or its ability to confer a creamy nature on the foods into which it will be incorporated.

However, the various conventional drying methods used by those skilled in the art do not make it possible to obtain this result. Thus, a protein-rich microalgal flour is generally prepared from unmilled microalgal biomass which is concentrated and then spray-dried or flash-dried.

Moreover, lipid-rich microalgal flour is generally prepared from microalgal biomass which has been mechanically lyzed and homogenized, the homogenate then being spray-dried or flash-dried.

In this second situation, the production of algal flour in fact requires the cells to be lyzed in order to release their oil.

For example, a pressure disruptor can be used to pump a suspension containing the cells through a restricted orifice so as to lyze the cells.

A high pressure (up to 1500 bar) is applied, followed by an instantaneous expansion through a nozzle.

The cells can be broken by three different mechanisms: running into the valve, high shear of the liquid in the orifice, and a sudden drop in pressure at the outlet, causing the cell to explode.

The method releases the intracellular molecules.

A Niro homogenizer (GEA Niro Soavi) or any other high-pressure homogenizer may be used to treat the cells having a size predominantly between 0.2 and 5 microns.

This treatment of the algal biomass under high pressure (approximately 1000 bar) generally lyzes more than 90% of the cells and reduces the size to less than 5 microns.

Alternatively, a ball mill is instead used.

In a ball mill, the cells are agitated in suspension with small spherical particles. The breaking of the cells is caused by the shear forces, the milling between the balls, and the collisions with balls.

These balls break the cells so as to release the cell content therefrom. The description of an appropriate ball mill is, for example, given in the U.S. Pat. No. 5,330,913.

A suspension of particles of smaller size than the cells of origin is then obtained in the form of an “oil-in-water” emulsion.

This emulsion is then spray-dried and the water is eliminated, leaving a dry powder containing the cell debris, intracellular liquid and oil.

However, the production of a powder which appears to be adhesive and cohesive and which flows with difficulty, since it contains oil in a content of 10%, 25% or even 50% by weight of the dry powder, is highly undesirable.

High lipids contents (more than 60%) are even considered to be even more difficult or even impossible to dry effectively.

Problems of wettability and water-dispersibility of dried biomass flours are also highly undesirable.

Moreover, these microalgal flours show no resistance and cannot be used in food formulations for their coating, gelling or even creamy nature.

### SUBJECT OF THE INVENTION

There is therefore still an unmet need for novel textured forms of (milled or unmilled) microalgal biomass flour, in order to make it possible to easily incorporate them, on a large scale, into food products which must remain delicious and nutritious.

The applicant company has found that this need can be met by providing a process for texturing microalgal biomass flour which comprises the following steps:

(a) introducing water, microalgal flour and, optionally, a vegetable protein source into a solid-liquid mixer,

(b) emulsifying and homogenizing the content of the solid-liquid mixer,

(c) optionally, placing the internal space of the mixer at low pressure or under vacuum.

In step (a), the microalgal flour is introduced in such a way that its solids content is between 20% and 50% by weight, preferably between 25% and 45% by weight of the mixture.

The vegetable protein source can be chosen from the group consisting of protein-rich microalgal biomass or biomass flour, cereals, oleaginous plants, leguminous plants and tuberous plants, used alone or in combination.

These vegetable protein sources are introduced into the reaction medium in an amount of from 10% to 50% by dry weight of said mixture.

Preferentially, steps (b) and (c) are carried out:
until a homogeneous emulsified pasty mixture is obtained, and
at a maximum temperature of between 50° C. and 90° C., and/or
at a shear rate of more than approximately 2000 s⁻¹, preferably at a shear rate of between 2500 and 10 000 s⁻¹, and/or
until phase conversion of the content of the solid-liquid mixer takes place, and/or
until an increase in the viscosity of the content of the solid-liquid mixer is detected and/or its color turns white, and/or
until an average diameter (D mode measured by laser particle size analysis) of the emulsion droplets of less than 10 μm is obtained.

In accordance with the present invention, step (b) and/or step (c) can be carried out at a temperature of between 50° C. and 90° C., preferably at a temperature between 65° C. and 85° C.

In accordance with the present invention, in step (b), the temperature can be increased up to a maximum value after mixing of the components.

In accordance with the present invention, step (b) and/or (c) is (are) carried out for at least 1 minute, preferably between 1 and 20 minutes, preferably between 1 and 5 minutes.

In accordance with the present invention, step (b) and/or step (c) can be carried out until the reaction medium is brought to a higher viscosity.

In accordance with the present invention, step (b) and step (c) are carried out:
at least partially at the same time,
simultaneously or
one after the other.

In accordance with the invention, the homogeneous emulsified pasty mixture can be pasteurized. The pasteurization can be carried out in step (b) and/or step (c) and subsequently. If the pasteurization is carried out in step (b), the temperature is preferably brought to a first temperature, for example 60° C., and subsequently brought to a second temperature, for example 65° C., at which the pasteurization takes place.

In accordance with the invention, the homogeneous emulsified pasty mixture can be treated at high temperature for a short time (process termed “High Temperature Short Time” or HTST or Ultra High Temperature or UHT).

This treatment can be carried out in step (b) and/or step (c) and subsequently. If the HTST treatment is carried out in step (b), the temperature is brought to a value below 100° C., for 30 seconds to 5 min.

According to another aspect of the invention, a process for texturing microalgal biomass flour is provided which comprises the following steps:

(a) introducing water, microalgal flour and, optionally, a vegetable protein source into a solid-liquid mixer,

(b) emulsifying and homogenizing the content of the solid-liquid mixer,

(c) placing the internal space of the mixer at low pressure or under vacuum, when a homogeneous emulsified pasty mixture is obtained at the end of step (b),

(d) sterilizing the paste in homogeneous emulsified form.

According to the invention, the homogeneous emulsified pasty mixture can be heated in step (d) at a temperature above approximately 120° C., preferably above approximately 130° C., and even more preferentially at a temperature above approximately 140° C.

In accordance with the invention, the homogeneous emulsified pasty mixture can be sterilized in step (d) for more than approximately 1 second, preferably for more than approximately 2 seconds, and preferably for approximately 3 seconds.

According to the invention, the homogeneous emulsified pasty mixture can be sterilized in step (d) for less than 5 seconds, preferably for less than approximately 4 seconds, and preferably for approximately 3 seconds.

In accordance with the present invention, in step (d), heating by steam infusion can be used for heating the homogeneous emulsified pasty mixture.

According to the present invention, in step (d), the homogeneous emulsified pasty mixture can be preheated to a first heat treatment temperature and then heated to the final heat treatment temperature.

In accordance with the invention, the first heat treatment temperature may be a temperature above 75° C., preferably more than 80° C. and preferably approximately 85° C.

In accordance with the invention, the final heat treatment temperature may be a temperature above approximately 120° C., preferably above 130° C. and preferably a temperature of approximately 140° C.

According to the present invention, in step (d), the homogeneous emulsified paste can be preheated by means of an indirect heat exchanger or of a surface heat exchanger, by steam injection.

The process in accordance with the present invention can also comprise the following step:

(e) cooling the heat-treated homogeneous emulsified paste after step (d).

In accordance with the present invention, in step (e), the homogeneous emulsified paste can be cooled by means of a heat exchanger, preferably by means of a scraped-surface heat exchanger or by flash cooling in a container under vacuum.

According to the present invention, in step (e), the temperature of the homogeneous emulsified paste can be cooled to a temperature below approximately 45° C., preferably below approximately 40° C.

The process in accordance with the present invention can also comprise the following step:

(f) adding compounds which promote the formation of the homogeneous emulsified paste, after step (e) and/or step (d).

These compounds which promote the formation of the homogeneous emulsified paste are chosen from the group consisting of phospholipids, mono-, di- and triglycerides, and gums.

According to the invention, the homogeneous emulsified paste can have a solids content of from 20% to 65% by weight and preferably from 40% to 50% by weight.

In accordance with the invention, the total solids content of the homogeneous emulsified paste after flash cooling is between 45% and 65%.

According to one aspect of the invention, the latter provides for a solid-liquid mixer and sterilization means.

According to the invention, the sterilization means may comprise a steam injection heating device.

According to one aspect of the invention, a device comprising a solid-liquid mixer and heating means, characterized in that the heating means comprise a steam injection heating device, is proposed.

The solid-liquid mixer used may be any mixer capable of mixing solids and liquids at the desired temperature and the desired shear rate. The mixer must have sufficient power to supply a shear rate of at least 5000 s⁻¹, preferably of at least 10 000 s⁻¹. It may have means for applying a vacuum in order to apply a low pressure or a vacuum in the head space of the solid-liquid mixer.

1-17. (canceled)

18. A process for texturing microalgal biomass flour, which comprises the following steps:
(a) introducing water, microalgal flour and, optionally, a vegetable protein source into a solid-liquid mixer,
(b) emulsifying and homogenizing the content of the solid-liquid mixer,
(c) optionally, placing the internal space of the mixer at low pressure or under vacuum.

19. The process as claimed in claim 18, wherein, in step (a), the microalgal flour is introduced in such a way that its solids content is between 20% and 50% by weight, preferably between 25% and 45% by weight of the mixture.

20. The process as claimed in claim 18, wherein steps (b) and (c) are carried out until a homogeneous emulsified pasty mixture is obtained.

21. The process as claimed in claim 18, wherein steps (b) and (c) are carried out at a temperature of between 50° C. and 90° C., preferably at a temperature of between 65° C. and 85° C.

22. The process as claimed in claim 18, wherein steps (b) and (c) are carried out at a shear rate of more than approximately 2000 s⁻¹, preferably of between 2500 and 10 000 s⁻¹.

23. The process as claimed in claim 18, wherein steps (b) and (c) are carried out until phase conversion of the content of the solid-liquid mixer takes place.

24. The process as claimed in claim 18, wherein steps (b) and (c) are carried out at a temperature which allows phase conversion of the content of the solid-liquid mixer.

25. The process as claimed in claim 18, wherein steps (b) and (c) are carried out until an increase in the viscosity of the content of the solid-liquid mixer is detected and/or its color turns white.

26. The process as claimed in claim 18, wherein steps (b) and (c) are carried out until an average diameter (D mode measured by laser particle size analysis) of the emulsion droplets of less than 10 μm is obtained.

27. The process as claimed in claim 18, wherein steps (b) and (c) are carried out for at least 1 minute, preferably between 1 and 20 minutes, preferably between 1 and 5 minutes.

28. The process as claimed in claim 18, wherein steps (b) and (c) are carried out:
at least partially at the same time,
simultaneously or
one after the other.

29. The process as claimed in claim 18, comprising a sterilizing step (d).

30. The process as claimed in claim 29, wherein step (d) consists in heating the homogeneous emulsified paste at a temperature above approximately 120° C., preferably above approximately 130° C., and preferably above approximately 140° C., for less than 5 seconds, preferably for less than approximately 4 seconds, and preferably for approximately 3 seconds.

31. The process as claimed in claim 29, comprising a step (e) of cooling the heat-treated homogeneous emulsified paste after step (d).

32. The process as claimed in claim 31, wherein the temperature of the homogeneous emulsified paste is cooled to a temperature below approximately 45° C., preferably below approximately 40° C.

33. The process as claimed in claim 31, comprising a step (f) which consists of the addition of compounds which promote the formation of the homogeneous emulsified paste, after step (e) and/or step (d).

34. The process as claimed in claim 33, wherein the compounds which promote the formation of the homogeneous emulsified paste are chosen from the group consisting of phospholipids, mono-, di- and triglycerides, and gums.
